(19) United States
(12) Patent Application Publication
(10) Pub. No.: US 2023/0109762 A1
(43) Pub. Date: Apr. 13, 2023

(54) VIDEO SIGNAL PROCESSING METHOD AND VIDEO SIGNAL PROCESSING DEVICE

(71) Applicant: YAMAHA CORPORATION, Hamamatsu-shi (JP)

(72) Inventor: Akihiko SUYAMA, Hamamatsu-shi (JP)

(21) Appl. No.: 17/960,372

(22) Filed: Oct. 5, 2022

(30) Foreign Application Priority Data
Oct. 12, 2021 (JP) 2021-167421

(51) Int. Cl. H04N 19/467; H04N 9/64; H04N 19/186; H04N 19/172; H04N 19/136; H04N 19/176

(52) U.S. Cl. CPC H04N 19/467; H04N 9/64; H04N 19/136; H04N 19/172; H04N 19/176; H04N 19/186

(57) ABSTRACT

A video signal processing method according to an embodiment includes receiving first data, generating second data by converting the first data into an RGB value, receiving a first video signal including an RGB value for each pixel, generating a second video signal from the first video signal by replacing an RGB value of a pixel in a first area in the first video signal with the RGB value of the second data, and outputting the second video signal

### CROSS-REFERENCE TO RELATED APPLICATIONS

This application is based on and claims priority under 35 USC 119 from Japanese Patent Application No. 2021-167421 filed on Oct. 12, 2021, the contents of which are incorporated herein by reference.

### Technical Field

An embodiment of the present invention relates to a video signal processing method and a video signal processing device for processing a video signal.

### Background Art

Patent Literature 1 describes a digital watermark information embedding device. The digital watermark information embedding device outputs an image signal in which digital watermark information is embedded.

Patent Literature 2 describes a data information embedding device and a reproducing device. The data information embedding device generates watermark information based on data information. The data information embedding device embeds the generated digital watermark information in a video/audio signal. The data information embedding device outputs the digital watermark information and the video/audio signal.

Patent Literature 3 describes a display control device. The display control device generates, based on image data, information such as a distance to a person at the time of image capturing as metadata. The display control device encodes a video and the metadata.

### CITATION LIST

### Patent Literature

Patent Literature 1: Japanese Patent No. 3587168
Patent Literature 2: JP2009-130374A
Patent Literature 3: JP2011-221844A

### SUMMARY OF INVENTION

Incidentally, there is a demand for distributing a video signal of a moving image and distributing data (hereinafter, referred to as data A) different from the video signal to be distributed. However, an existing moving image distribution platform only distributes the video signal of the moving image, and may not be able to distribute the data A.

An object of an embodiment of the present invention is to provide a video signal processing method capable of distributing a video signal and distributing data different from the video signal even in an existing moving image distribution platform.

A video signal processing method according to an embodiment of the present invention includes
receiving first data;
generating second data by converting the first data into an RGB value;
receiving a first video signal including an RGB value for each pixel;
generating a second video signal from the first video signal by replacing an RGB value of a pixel in a first area in the first video signal with the RGB value of the second data; and
outputting the second video signal.

According to the video signal processing method in the embodiment of the present invention, it is possible to distribute a video signal and to distribute data different from the video signal even in an existing moving image distribution platform.

### BRIEF DESCRIPTION OF DRAWINGS

FIG. 1 is a block diagram showing an example of a configuration of a video signal processing device 20 that executes a video signal processing method according to a first embodiment;

FIG. 2 is a diagram showing an example of connection among the video signal processing device 20, a terminal 30, and a server 40;

FIG. 3 is a diagram showing a concept of two or more frames;

FIG. 4 is a flowchart showing an example of processing in the video signal processing device 20;

FIG. 5 is a diagram showing movement of data in the video signal processing device 20;

FIG. 6 is a diagram showing a concept of data processing in the video signal processing device 20;

FIG. 7 is a flowchart showing an example of decoding processing for a second video signal Vd2;

FIG. 8 is a diagram showing an area a1 including 4 × 4 pixels;

FIG. 9 is a diagram showing an example of conversion of first data D1 including an identifier data ID;

FIG. 10 is a flowchart showing an example of decoding processing executed by the terminal 30 in a modification 3;

FIG. 11 is a diagram showing an example of processing in a video signal processing device 20d;

FIG. 12 is a flowchart showing an example of decoding processing executed by the terminal 30 in a modification 4;

FIG. 13 is a diagram showing an example of processing in a video signal processing device 20e;

FIG. 14 is a diagram showing an example of processing in the terminal 30; and

FIG. 15 is a diagram showing an application example 1 of the video signal processing devices 20 and 20a to 20e.

### DESCRIPTION OF EMBODIMENTS

### First Embodiment

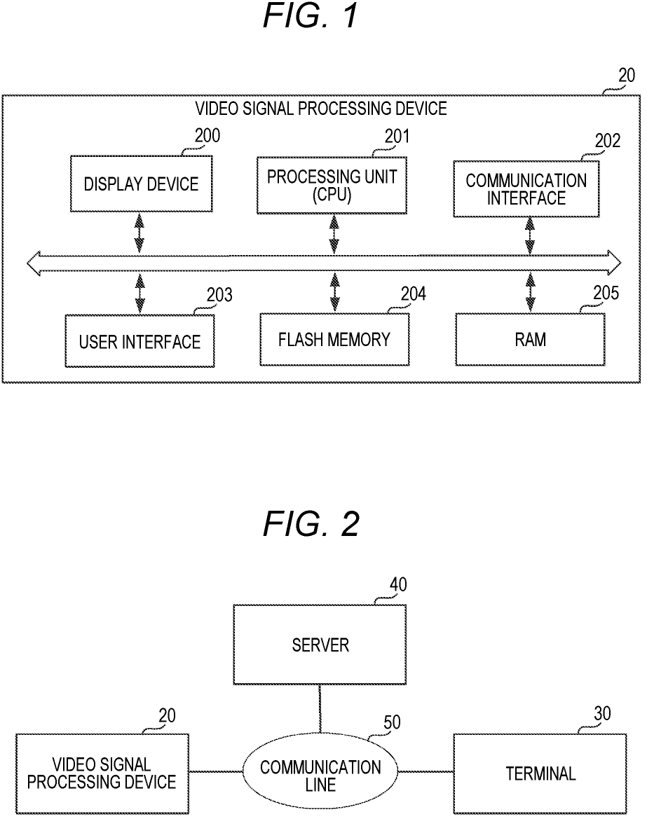

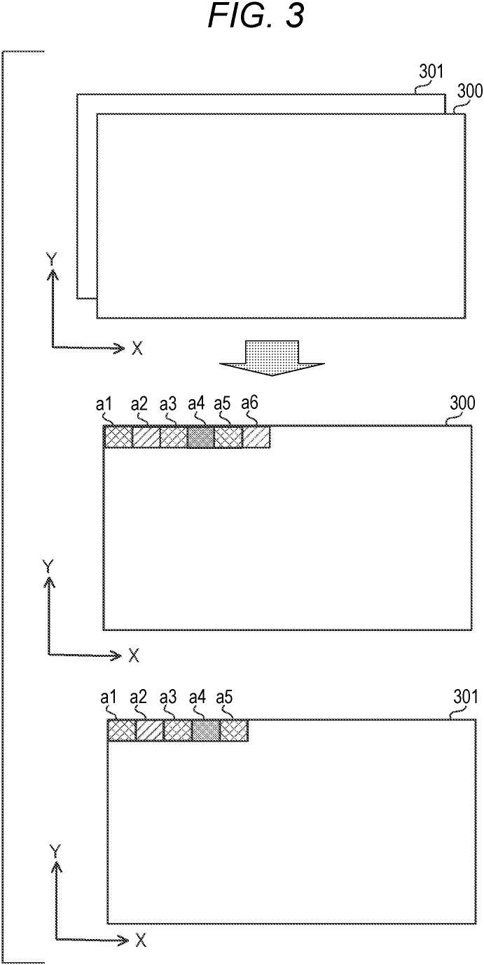

Hereinafter, a video signal processing method according to a first embodiment will be described with reference to the drawings. FIG. 1 is a block diagram showing an example of a configuration of a video signal processing device 20 that executes the video signal processing method. FIG. 2 is a block diagram showing an example of connection among the video signal processing device 20, a terminal 30, and a server 40. FIG. 3 is a diagram showing a concept of two or more frames.

The video signal processing device 20 is a device that generates a video signal. In the present embodiment, the video signal includes data for causing a video reproducing device to display a video. In the present embodiment, the video signal includes a video signal or the like obtained by decoding a signal transmitted in a compressed state. Display of a display provided in the video reproducing device changes based on the video signal. Therefore, the video signal includes, for example, data of an RGB value for each pixel. The video signal is a signal related to reproduction of a moving image, and thus includes two or more frames. The video reproducing device reproduces the moving image by sequentially outputting each of the two or more frames to the display.

As shown in FIG. 1, the video signal processing device 20 includes a display device 200, a processing unit 201, a communication interface 202, a user interface 203, a flash memory 204, and a random access memory (RAM) 205.

The flash memory 204 stores various programs. The various programs include, for example, a program for operating the video signal processing device 20, or an application program for generating a video signal.

The RAM 205 temporarily stores a predetermined program stored in the flash memory 204.

The processing unit 201 includes a central processing unit (CPU), and controls an operation of the video signal processing device 20. Specifically, the processing unit 201 executes various operations by reading a program stored in the flash memory 204 into the RAM 205.

The communication interface 202 communicates with a device (hereinafter, referred to as an external device) different from the video signal processing device 20 via a communication line. The video signal processing device 20 and the external device are connected to each other in a wireless or wired manner such as Wi-Fi (registered trademark) or Bluetooth (registered trademark). The communication interface 202 is, for example, a USB, HDMI (registered trademark), or a network interface. The communication interface 202 corresponds to an output unit in the present invention.

The display device 200 displays various information based on an operation of the processing unit 201. The display device 200 is, for example, a liquid crystal display or an organic EL display.

The user interface 203 receives an operation on the video signal processing device 20 from a user of the video signal processing device 20. The user interface 203 is, for example, a keyboard, a mouse, or a touch panel.

The video signal processing device 20 as described above is, for example, a smartphone or a PC.

As shown in FIG. 2, the video signal processing device 20 is communicably connected to the terminal 30 and the server 40 via a communication line 50. The terminal 30 is an example of a device different from the video signal processing device 20. In this case, the video signal processing device 20 communicates with the terminal 30 and the server 40 via the communication interface 202. The communication line 50 is, for example, an Internet line.

The communication line 50 may not necessarily be the Internet line. The video signal processing device 20, the terminal 30, and the server 40 may communicate with each other via a private network or the like that is not connected to the Internet.

The server 40 receives and stores the video signal generated by the video signal processing device 20. Specifically, the server 40 receives the video signal from the video signal processing device 20 via the communication line 50. The server 40 stores the received video signal. The server 40 constitutes a moving image distribution platform.

The terminal 30 is connected to the server 40 to receive and reproduce the video signal. Specifically, the terminal 30 receives and reproduces the video signal distributed by the server 40 which is the moving image distribution platform. Accordingly, a user of the terminal 30 can view a video related to the video signal. Such a terminal 30 is, for example, a smartphone or a PC.

The video signal processing device 20 according to the present embodiment embeds data different from the video signal in the video signal. Specifically, the video signal processing device 20 generates a second video signal Vd2 by embedding, in a first video signal Vd1 input from a video camera or the like, data different from the first video signal Vd1. The first video signal Vd1 is an example of the video signal. Therefore, the first video signal Vd1 includes an RGB value for each pixel. The first video signal Vd1 includes two or more frames. For example, as shown in FIG. 3, the first video signal Vd1 includes a first frame 300 and a second frame 301. Hereinafter, in order to make a description easy to understand, directions are defined as shown in FIG. 3. Specifically, a direction in which areas a1 to a6 are arranged in the first frame 300 is defined as an X-axis direction. A direction orthogonal to the X-axis direction in the first frame 300 is defined as a Y-axis direction.

The data different from the first video signal Vd1 is, for example, illumination data. Specifically, the illumination data is data for controlling illumination. For example, an illumination device changes brightness of the illumination, a color of the illumination, and the like based on the illumination data. Hereinafter, the data different from the first video signal Vd1 described above is referred to as first data D1. Therefore, in the present embodiment, the video signal processing device 20 embeds, in the first video signal Vd1, the first data D1 which is the illumination data.

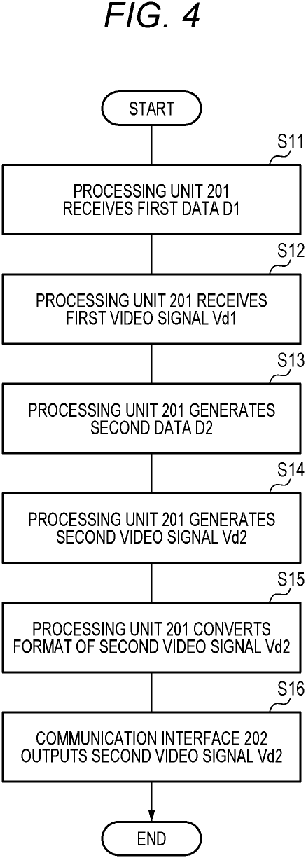

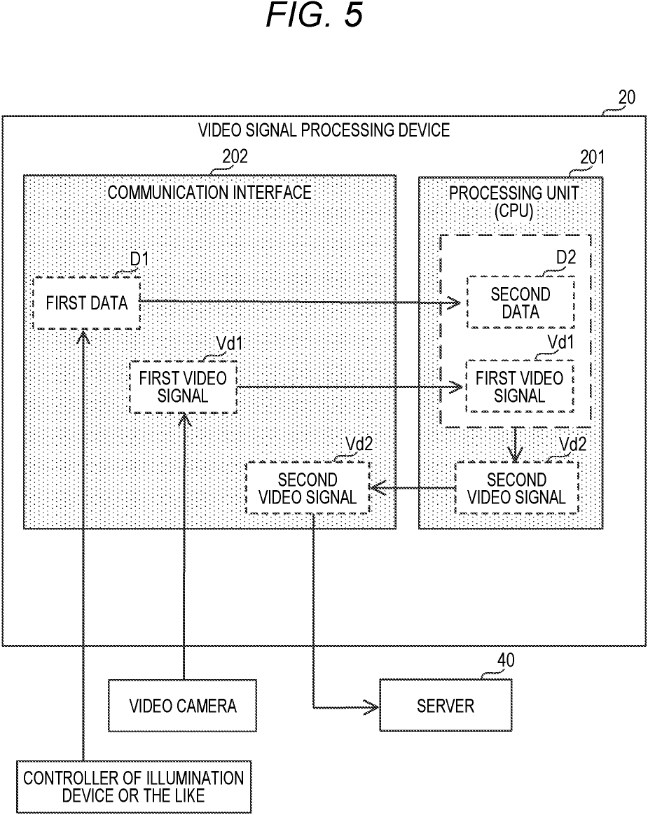

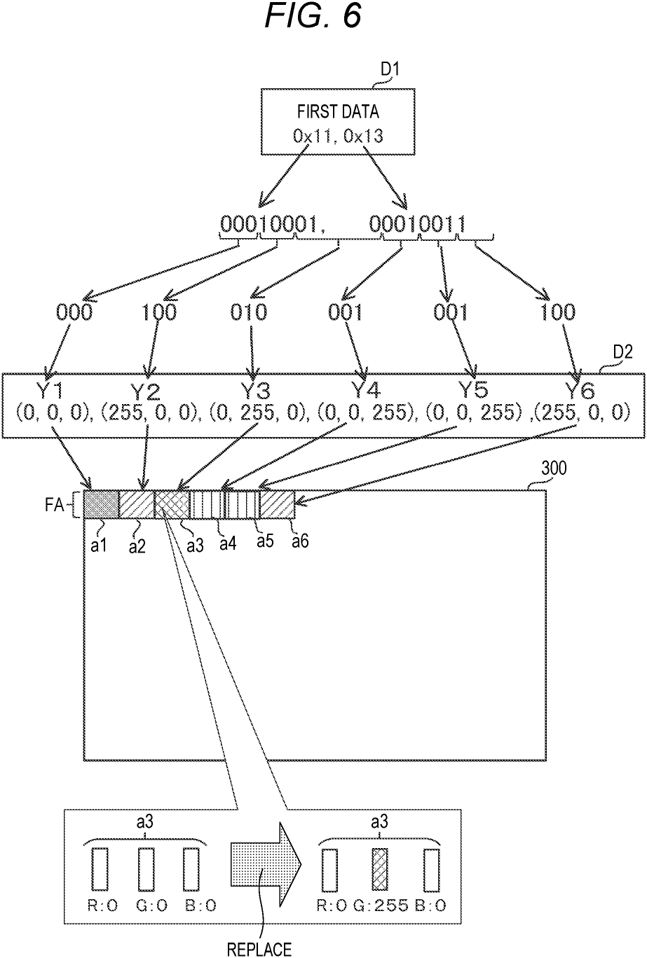

Hereinafter, processing of generating the second video signal Vd2 by the video signal processing device 20 will be described in more detail with reference to the drawings. FIG. 4 is a flowchart showing an example of the processing in the video signal processing device 20. FIG. 5 is a diagram showing a concept of movement of data in the video signal processing device 20. FIG. 6 is a diagram showing a concept of data processing in the video signal processing device 20.

For example, when an application program related to video signal processing is executed, the video signal processing device 20 starts processing of generating the second video signal Vd2 (FIG. 4: START).

First, the processing unit 201 receives the first data D1 (FIG. 4: step S11). Specifically, in the present embodiment, the communication interface 202 receives the first data D1 from a controller of the illumination device or the like (see FIG. 5). Then, the processing unit 201 receives the first data D1 from the communication interface 202. The processing unit 201 may generate the first data D1 based on, for example, a control signal of the illumination device recorded in advance in the video signal processing device 20. Alternatively, the processing unit 201 may receive a control signal of the illumination device recorded in advance in the controller of the illumination device or the like, and generate the first data D1 based on the received control signal of the illumination device.

Next, the processing unit 201 receives the first video signal Vd1 (FIG. 4: step S12). For example, the communication interface 202 receives the first video signal Vd1 from a video camera or the like for capturing a moving image (see FIG. 5). Then, the processing unit 201 receives the first video signal Vd1 from the communication interface 202.

Next, the processing unit 201 generates second data D2 by converting the received first data D1 into an RGB value (FIG. 4: step S13). For example, as shown in FIG. 6, the processing unit 201 converts byte values of the first data D1 into bit values. In an example shown in FIG. 6, the processing unit 201 converts byte values of “0x11, 0x13” of the first data D1 into bit values of “00010001, 00010011”. Accordingly, the processing unit 201 can obtain the first data D1 constituted by bit strings.

After the conversion, the processing unit 201 divides the bit strings of the first data D1 every three bits. In the example shown in FIG. 6, the bit strings of the first data D1 are “00010001, 00010011”. Therefore, the processing unit 201 obtains one or more bit strings “000, 100, 010, 001, 001, 100” divided every three bits. When a remainder of one bit or two bits is generated, the processing unit 201 obtains a bit string of three bits by adding 0 bit.

The processing unit 201 converts each of the bit strings divided every three bits into an RGB value. For example, as shown in FIG. 6, the processing unit 201 converts the bit string “010” divided into three bits into an RGB value of RGB = (0, 255, 0). In the present embodiment, a value of a first bit in the three bits corresponds to an R value in the RGB value. Specifically, when the first bit in the three bits is “1”, the processing unit 201 obtains a conversion result of R = 255. On the other hand, when the value of the most significant bit in the three bits is “0”, the processing unit 201 obtains a conversion result of R = 0. Similarly, a value of a second most significant bit in the three bits corresponds to a G value in the RGB value. Similarly, a value of a least significant bit in the three bits corresponds to a B value in the RGB value.

The processing unit 201 generates the second data D2 by converting all the bit strings divided every three bits into RGB values (see FIG. 6). Hereinafter, a first RGB value of the second data D2 is referred to as an RGB value Y1 (see FIG. 6). A second RGB value of the second data D2 is referred to as an RGB value Y2. A third RGB value of the second data D2 is referred to as an RGB value Y3. A fourth RGB value of the second data D2 is referred to as an RGB value Y4. A fifth RGB value of the second data D2 is referred to as an RGB value Y5. A sixth RGB value of the second data D2 is referred to as an RGB value Y6.

Next, the processing unit 201 generates the second video signal Vd2 based on the first video signal Vd1 and the second data D2 (FIG. 4: step S14). Specifically, the processing unit 201 replaces a part of the RGB values of the first video signal Vd1 with the RGB values of the second data D2. For example, as shown in FIG. 6, the processing unit 201 designates one or more areas a1 to a6 in a part of a frame (for example, the first frame 300) in the first video signal Vd1. The areas a1 to a6 each have the same number of pixels, for example, 4 × 4 pixels. Hereinafter, an area including the areas a1 to a6 is referred to as a first area FA.

Next, the processing unit 201 replaces RGB values of the areas a1 to a6 with the RGB values of the second data D2. For example, the processing unit 201 replaces the RGB value of the area a3 with the RGB value Y3. In this case, for example, the processing unit 201 replaces the RGB value of the area a3 from (0, 0, 0) to (0, 255, 0) (see FIG. 6). Similarly, in the present embodiment, the processing unit 201 replaces the RGB values of the pixels in the areas a1, a2, a4, a5, and a6 with the RGB values Y1, Y2, Y4, Y5, and Y6, respectively. In other words, the processing unit 201 generates the second video signal Vd2 by replacing the RGB values of the pixels in the areas a1 to a6 in the received first video signal Vd1 with the RGB values of the second data D2. The processing unit 201 may replace the areas a1 to a6 and an area other than the areas a1 to a6 in the first area FA with a single RGB value (for example, RGB = (0, 0, 0) or the like).

When the first video signal Vd1 includes two or more frames, the processing unit 201 replaces RGB values in each of the two or more frames. For example, as shown in FIG. 3, when the first video signal Vd1 includes the first frame 300 and the second frame 301, the processing unit 201 generates the second video signal Vd2 by replacing the RGB values of the pixels in the areas a1 to a6 of the first frame 300 with the RGB values of the second data D2 and replacing RGB values of pixels in areas a1 to a6 of the second frame 301 with the RGB values of the second data D2.

After the second video signal Vd2 is generated, in the present embodiment, the processing unit 201 converts a format of the second video signal Vd2 (FIG. 4: step S15). The processing unit 201 converts the second video signal Vd2 into a moving image format such as MPEG4. The processing unit 201 outputs the format-converted second video signal Vd2 to the communication interface 202 (see FIG. 5). Then, as shown in FIG. 5, the communication interface 202 outputs the format-converted second video signal Vd2 to the server 40 (FIG. 4: step S16).

By executing processing from step S11 to step S16 described above, execution of a series of processing in the video signal processing device 20 is completed (FIG. 4: END).

The processing described above is an example. Therefore, the video signal processing device 20 does not necessarily need to generate the second video signal Vd2 by the processing described above. For example, the processing unit 201 may compress the second video signal Vd2 and output the compressed second video signal Vd2 to the server 40. For example, the processing unit 201 may compress the first data D1 and convert the compressed first data D1 into a bit string.

### Example of Decoding Processing for Second Video Signal Vd2

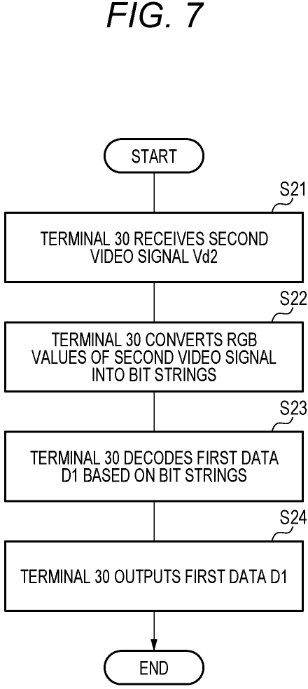

Hereinafter, decoding processing for the second video signal Vd2 in the terminal 30 will be described with reference to FIG. 7. FIG. 7 is a flowchart showing an example of the decoding processing for the second video signal Vd2.

First, the terminal 30 receives the second video signal Vd2 (FIG. 7: step S21). Specifically, as shown in FIG. 5, the terminal 30 receives the second video signal Vd2 distributed by the server 40.

Next, the terminal 30 decodes the second video signal Vd2. Specifically, the second video signal Vd2 converted into the moving image format such as MPEG4 is decoded into a data string or the like from which pixel data can be extracted. Thereafter, the terminal 30 extracts the RGB values of a part of the pixels in the second video signal Vd2 and converts the RGB values into bit strings (FIG. 7: step S22). The terminal 30 converts each of the RGB values (RGB values Y1 to Y6) of the pixels in the areas a1 to a6 into a bit string divided into three bits. For example, the terminal 30 converts RGB = (0, 255, 0) into a bit string “010”.

Next, the terminal 30 converts the first data D1 into byte strings based on the bit strings obtained by the conversion (FIG. 7: step S23). The terminal 30 outputs the first data D1 converted into the byte strings (FIG. 7: step S24).

By executing processing from step S21 to step S24 described above, the decoding processing in the terminal 30 is completed (FIG. 7: END).

For example, the terminal 30 reads the first data D1 output after decoding. At this time, the terminal 30 executes processing based on the first data D1. For example, when the illumination data is included in the decoded first data D1, the terminal 30 controls the illumination based on the illumination data. In this case, the terminal 30 functions as, for example, an illumination controller that controls illumination. The terminal 30 may not necessarily read the first data D1. For example, when the terminal 30 is a PC or the like, the terminal 30 may output the first data D1 to the illumination controller.

### Example of Method of Calculating Bit Values in Step S22

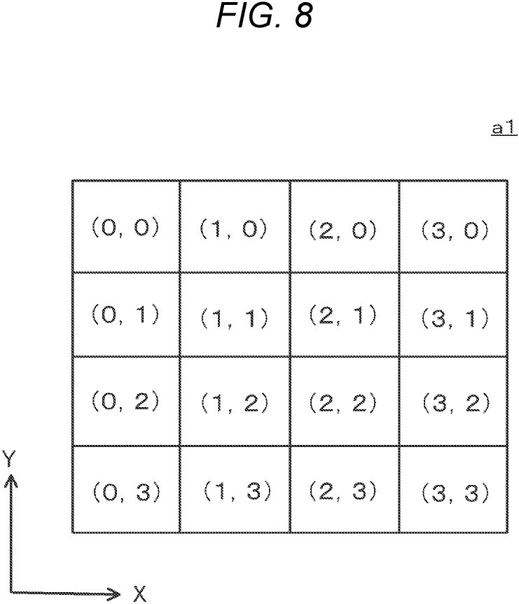

Hereinafter, a method of calculating bit values in step S22 will be described with reference to FIG. 8. FIG. 8 is a diagram showing the area a1 including 4 × 4 pixels.

In FIG. 8, the area a1 includes 16 pixels from a pixel (0, 0) to a pixel (3, 3). In FIG. 8, the pixels (0, n), (1, n), (2, n), and (3, n) are arranged in this order in a positive direction of an X axis (n is any number from 1 to 3). The pixels (m, 0), (m, 1), (m, 2), and (m, 3) are arranged in this order in a negative direction of a Y axis (m is any number from 1 to 3). In this case, for example, the terminal 30 calculates a bit string with (Method 1), (Method 2), (Method 3), or (Method 4) described below.

### Method 1

An RGB value of a first pixel among the pixels in the area a1 is extracted and converted into a bit string. For example, the first pixel in the area a1 is the pixel (0, 0). Therefore, the terminal 30 extracts an RGB value of the pixel (0, 0) and converts the RGB value into a bit string. For example, when the RGB value of the pixel (0, 0) in the area a1 is RGB = (0, 255, 0), the terminal 30 converts the area a1 into a bit string “010”.

### Method 2

An RGB value of a pixel located near a center of the area a1 is extracted and converted into a bit string. For example, in an example shown in FIG. 8, the pixels (1, 1), (2, 1), (1, 2), and (2, 2) are located near the center of the area a1. Therefore, the terminal 30 converts an RGB value of any one of the pixels (1, 1), (2, 1), (1, 2), and (2, 2) into a bit string. For example, the terminal 30 extracts an RGB value of the pixel (1, 1) and converts the RGB value into a bit string.

### Method 3

RGB values of pixels located near the center of the area a1 are extracted and averaged, and an averaged RGB value is converted into a bit string. For example, when the RGB value of the pixel (1, 1) is (255, 0, 253), an RGB value of the pixel (2, 1) is (252, 0, 252), an RGB value of the pixel (1, 2) is (252, 0, 252), and an RGB value of the pixel (2, 2) is (253, 0, 255), an average of the RGB values is RGB = (253, 0, 253). In this case, for example, the terminal 30 converts an RGB value of 128 or more to bit: 1, and converts an RGB value of 127 or less to bit: 0. Therefore, the terminal 30 converts RGB = (253, 0, 253) into a bit string “101”.

### Method 4

All RGB values of the 4 × 4 pixels are extracted and averaged. A method of averaging RGB values of a plurality of pixels is the same as (Method 3), a description thereof will be omitted.

When the RGB values of the plurality of pixels are averaged as in (Method 3) or (Method 4), even when a part of the RGB values of the pixels is changed due to noise or the like generated at the time of compression, a possibility of normal restoration is increased.

The terminal 30 may include a graphics processing unit (GPU). In this case, the GPU may execute the bit value calculation processing described above. The GPU has a high calculation speed related to image processing. Therefore, when the terminal 30 is reading the second video signal Vd2, a delay is less likely to occur in the decoding processing. Therefore, in distribution of a moving image requiring real-time performance, it is possible to distribute the moving image without a delay.

### Effects of First Embodiment

According to the video signal processing device 20, both the video signal and the data different from the video signal can be distributed as one video signal. More specifically, the processing unit 201 generates the second video signal Vd2 by replacing the RGB values of the pixels in the areas a1 to a6 in the received first video signal Vd1 with the RGB values based on the first data D1. Accordingly, the video signal processing device 20 can generate the second video signal Vd2 in which the first data D1 (the data different from the video signal) is embedded in the first video signal Vd1. An existing moving image distribution platform can distribute the second video signal Vd2 which is a video signal. The terminal 30 that receives the distributed video signal can decode the first data D1, and execute predetermined processing based on the first data D1. For example, when the illumination data is included in the first data D1, the terminal 30 can control the illumination based on the illumination data. Accordingly, the terminal 30 can control, for example, illumination at a public viewing venue in the same manner as illumination at a live venue as a distribution source. As a result, the user can view a captured moving image of the live venue under the illumination controlled in the same manner as the live venue. As described above, a distributor can distribute both the video signal and the data different from the video signal using the existing moving image distribution platform.

The terminal 30 can synchronously execute reproduction processing for the video signal and processing different from the reproduction of the video signal. Specifically, in the second video signal Vd2, one video frame contains data (that is, the first data D1) reproduced in synchronization with the frame. Therefore, when the terminal 30 reads each frame of the second video signal Vd2, the terminal 30 simultaneously reads the first data D1 embedded in the frame. The terminal 30 executes the processing related to the first data D1 at the same timing as each frame of a video reproduced by the second video signal Vd2. Accordingly, the terminal 30 can synchronously execute the reproduction processing for the video signal and processing related to the video signal (for example, the control of the illumination).

In particular, when the first data D1 includes the illumination data, the video displayed based on the second video signal Vd2 is synchronized with an illumination operation (for example, turning on, blinking, or luminance adjustment). Therefore, for example, the distributor prepares a video of a live performance scene as the first video signal Vd1. Similarly, the distributor prepares the first data D1 including the illumination data. The distributor uses the video signal processing device 20 to embed the illumination data (the first data) in the first video signal Vd1 to generate the second video signal Vd2. Accordingly, when the terminal 30 reads the second video signal Vd2, the terminal 30 controls illumination in accordance with a live performance. Therefore, even when a viewer is in a place other than a live venue, it is possible to obtain a sense of realism as if the viewer is viewing the live performance at the live venue.

When data is to be embedded in a video signal (an image), there is a method of embedding the data in the image using, for example, a digital watermark. In a case of the digital watermark, in addition to processing of embedding the data in the video signal, additional processing such as hiding the embedded data is executed. Therefore, when reading the data embedded in the video signal using the digital watermark, a terminal needs to execute an algorithm for reading the embedded data, and an algorithm (hereinafter, referred to as an algorithm V1) such as analysis of hidden information.

On the other hand, in the present embodiment, the processing unit 201 generates the second video signal Vd2 by replacing the RGB values of the pixels in the areas a1 to a6 in the first video signal Vd1 with the RGB values of the second data D2. In this case, the terminal 30 reads the bit values based on the RGB values in the decoding. Here, an algorithm for converting the RGB values into the bit values is not complicated as compared with the algorithm V1. Therefore, a calculation load generated in decoding processing for the second data D2 is lower than that of the algorithm V1. Accordingly, when the terminal 30 is reading the second video signal Vd2, the delay is less likely to occur in the decoding processing. Therefore, in the distribution of the moving image requiring the real-time performance, according to the video signal processing method in the present embodiment, it is possible to execute distribution and reproduction processing with a delay lower than that of an existing digital watermark or the like.

### Modification 1 of Video Signal Processing Device 20

Hereinafter, a video signal processing device 20a according to a modification 1 will be described. A processing unit 201a (not shown) of the video signal processing device 20a compresses the second video signal Vd2 in a certain block unit. Here, the number of pixels in each of the areas a1 to a6 is the same as the number of pixels in the block unit of the second video signal Vd2. For example, when the block unit of the processing unit 201a is eight pixels, the processing unit 201a sets the number of pixels in each of the areas a1 to a6 to eight pixels. The processing unit 201a compresses the second video signal Vd2 in the block unit of eight pixels.

### Effects of Modification 1

According to the video signal processing device 20a, the second video signal Vd2 is less likely to be affected by the compression. When the number of pixels in the block unit is different from the number of pixels in each area to be replaced, for example, the processing unit mixes and compresses the area a1 and the area a2. In this case, information on RGB values of pixels in the area a1 and information on RGB values of pixels in the area a2 are mixed, and the information on each area is lost. Therefore, the RGB values of the pixels in the area a1 and the area a2 may not return to the respective RGB values before compression at the time of decoding. On the other hand, in the present modification, the number of pixels in each of the areas a1 to a6 is the same as the number of pixels in the block unit of the second video signal Vd2. For example, when the block unit of the second video signal Vd2 is eight pixels, the RGB value of each of the areas a1 to a6 is eight pixels. In this case, for example, the processing unit 201a compresses the area a1 and the area a2 without mixing. Therefore, the RGB values of the pixels in the area a1 and the area a2 return to the respective RGB values before decoding at the time of decoding without losing the information on the RGB values of the pixels in the area a1 and the area a2.

### Modification 2 of Video Signal Processing Device 20

Hereinafter, a video signal processing device 20b according to a modification 2 of the video signal processing device 20 will be described with reference to FIG. 3. The video signal processing device 20b compresses the second video signal Vd2 independently for each frame.

In the present modification, a processing unit 201b (not shown) of the video signal processing device 20b replaces RGB values of areas a1 to a6 of each of two or more frames with RGB values of the second data D2. The processing unit 201b compresses the frame included in the second video signal Vd2 independently. In other words, the first frame 300 shown in FIG. 3 is intra-frame compressed, and the second frame 301 shown in FIG. 3 is intra-frame compressed. For example, the processing unit 201b replaces the RGB values of the areas a1 to a6 of each of the first frame 300 and the second frame 301 with the RGB values of the second data D2. The processing unit 201b compresses the first frame 300 and the second frame 301 independently. The communication interface 202 outputs the compressed second video signal Vd2.

### Effects of Modification 2

In the present modification, the RGB values of the areas a1 to a6 of each of the two or more frames are independently replaced. As a method of compressing the second video signal Vd2, there is inter-frame compression. The inter-frame compression is a compression method of recording only a difference in data of adjacent frames. That is, the inter-frame compression is executed by extracting and compressing only portions having different RGB values in a plurality of frames. That is, when the second video signal Vd2 is compressed using the inter-frame compression, if data having the same RGB value is embedded in the same pixel, the embedded data may be lost. Accordingly, the RGB value of the pixel may not return to a state before encoding at the time of decoding.

On the other hand, the processing unit 201b compresses each frame included in the second video signal Vd2 independently. In this case, unlike the inter-frame compression, there is a low possibility that data embedded in the second video signal Vd2 (data embedded by replacing the RGB values) is lost. Therefore, a possibility that the terminal 30 can correctly decode the first data D1 is increased.

### Modification 3 of Video Signal Processing Device 20

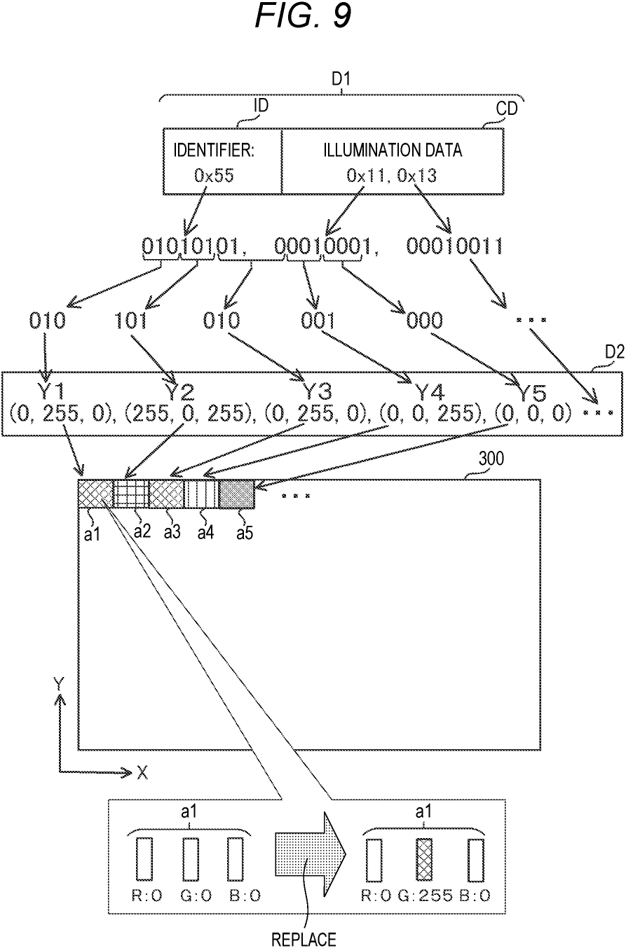

Hereinafter, a video signal processing device 20c according to a modification 3 will be described with reference to the drawings. FIG. 9 is a diagram showing an example of conversion of the first data D1 including an identifier data ID. In FIG. 9, a description of the area a6 is omitted. The video signal processing device 20c is different from the video signal processing device 20 in that the video signal processing device 20c generates the second video signal Vd2 based on the first data D1 including the identifier data ID. Hereinafter, details will be described.

A processing unit 201c (not shown) of the video signal processing device 20c generates the first data D1 by, for example, adding the identifier data ID to illumination data CD (see FIG. 9). The identifier data ID is data for determining whether the first data D1 is embedded in the second video signal Vd2 (whether the second video signal Vd2 includes second data). That is, the first data D1 includes the identifier data ID for identifying that the first data D1 is embedded. When the first data D1 includes the identifier data ID, it can be determined that the second video signal Vd2 is generated by the video signal processing method according to the present embodiment. In the present modification, the identifier data ID and the illumination data CD are arranged in order from a most significant bit in the first data D1 (see FIG. 9). In an example shown in FIG. 9, the identifier data ID has a byte value of “0x55”.

The processing unit 201c converts the first data D1 including the identifier data into the second data D2. Since processing in the video signal processing device 20c after the processing unit 201c converts the first data D1 into the second data D2 is the same as that in the video signal processing device 20, a description thereof will be omitted.

### Example of Decoding Processing in Modification 3

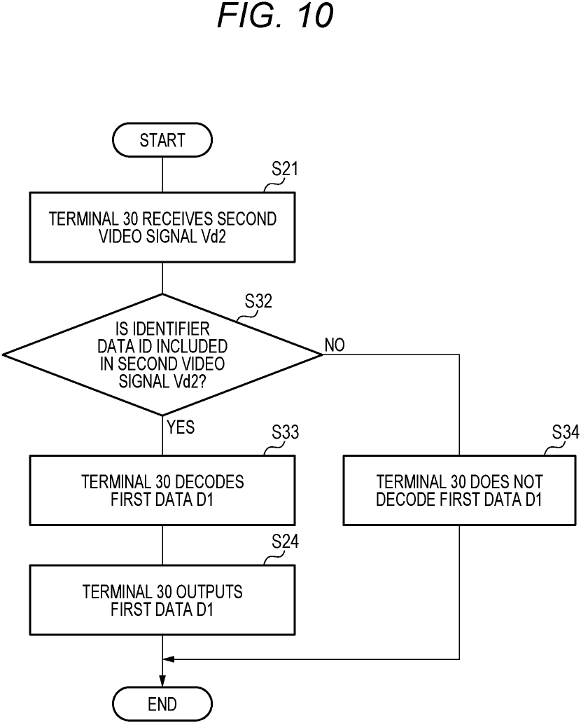

Hereinafter, an example of decoding processing executed by the terminal 30 in the modification 3 will be described with reference to FIG. 10. FIG. 10 is a flowchart showing the example of the decoding processing executed by the terminal 30 in the modification 3.

In the present modification, after step S21, the terminal 30 determines whether the identifier data ID is included in the second video signal Vd2 (FIG. 10: step S32). For example, in the example shown in FIG. 9, the identifier data ID replaced with RGB values is embedded in the areas a1, a2, and a3. Therefore, the terminal 30 converts the RGB value of each of the areas a1, a2, and a3 into a bit value. The terminal 30 extracts a first 8-bit value from the converted bit values. Accordingly, it is determined whether the identifier data ID is included in the second video signal Vd2. That is, the terminal 30 can determine whether the identifier data ID is included in the second video signal Vd2 by extracting RGB values of at least three areas among the areas included in the first area FA.

When the terminal 30 determines that the identifier data ID is included in the second video signal Vd2 (FIG. 10: Yes in step S32), the terminal 30 decodes the first data D1 based on RGB values of pixels in the areas a1 to a6 in the second video signal Vd2 (FIG. 10: step S33).

When the terminal 30 determines that the identifier data ID is not included in the second video signal Vd2 (FIG. 10: No in step S32), the terminal 30 does not decode the first data D1 (FIG. 10: step S33). After step S33, the terminal 30 executes step S24.

### Effects of Modification 3

The video signal processing device 20c first decodes a data block in which the identifier data ID is stored. When the identifier data ID is not stored in the second video signal Vd2, the terminal 30 does not execute the decoding processing for the first data D1, and thus does not execute unnecessary decoding processing. More specifically, when the terminal 30 determines that the identifier data ID is included in the second video signal Vd2, the terminal 30 decodes the first data D1 based on the RGB values of the pixels in the areas a1 to a6 in the second video signal Vd2. Therefore, when the decoding of the first data D1 is unnecessary, the terminal 30 can only reproduce an input video signal without executing the processing of decoding the first data D1.

### Modification 4 of Video Signal Processing Device 20

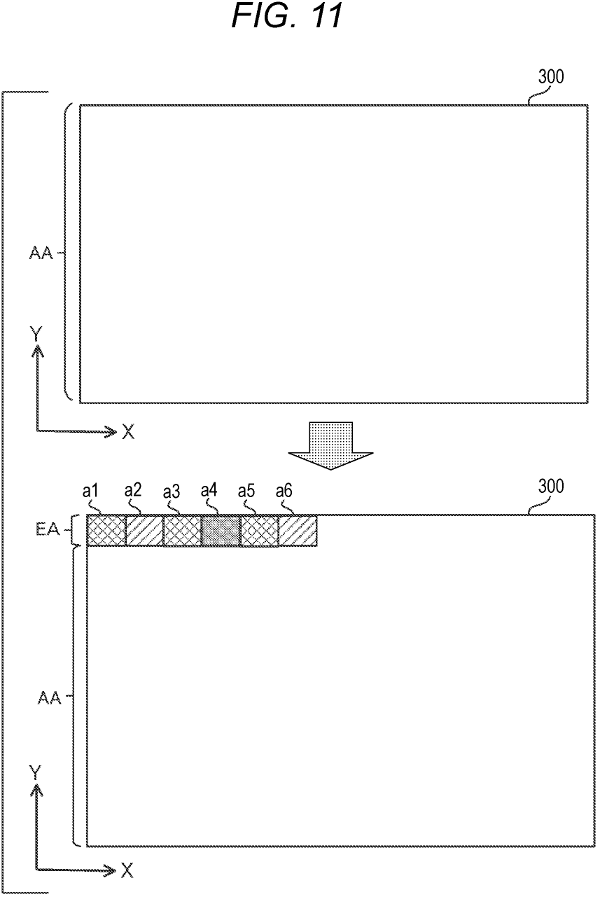

Hereinafter, a video signal processing device 20d according to a modification 4 will be described with reference to FIG. 11. FIG. 11 is a diagram showing an example of processing in the video signal processing device 20d. The video signal processing device 20d is different from the video signal processing device 20 in that a size of a video displayed based on the first video signal Vd1 is expanded.

Similarly to FIG. 3, a direction in which the areas a1 to a6 in the first frame 300 in FIG. 11 are arranged is defined as an X-axis direction. A direction orthogonal to the X-axis direction in the first frame 300 is defined as a Y-axis direction.

The video signal processing device 20d includes a processing unit 201d (not shown) instead of the processing unit 201. The processing unit 201d expands the number of pixels in the first video signal Vd1. For example, as shown in FIG. 11, the processing unit 201d expands the number of pixels in the Y-axis direction of the first frame 300. For example, the processing unit 201d expands the number of pixels in the first video signal Vd1 from 1280 × 720 to 1280 ×724. Accordingly, as shown in FIG. 11, the first video signal Vd1 has an area AA before expansion and an expanded area EA. The processing unit 201d designates the expanded area EA in the first video signal Vd1 as the areas a1 to a6. The processing unit 201d replaces RGB values of pixels in the area EA designated as the areas a1 to a6 with RGB values of the second data D2. For example, when the processing unit 201d expands the number of pixels in the first video signal Vd1 from 1280 × 720 to 1280 × 724, the processing unit 201d designates a total of 320 areas, each of which is 4 ×4 pixels among the expanded 1280 × 4 pixels, as areas for replacement.

In a case of the example described above, RGB values of pixels in an expanded 1280 × 4 area are replaced. In this case, the processing unit 201d displays an original video signal (the first video signal Vd1 before conversion) in the area AA without replacing RGB values of pixels in the original video signal. That is, it is not necessary to replace RGB values of a part of pixels in the original video signal (the first video signal Vd1 before conversion). That is, an original image (a video based on the first video signal) can be held by expanding the pixels.

### Example of Decoding Processing in Modification 4

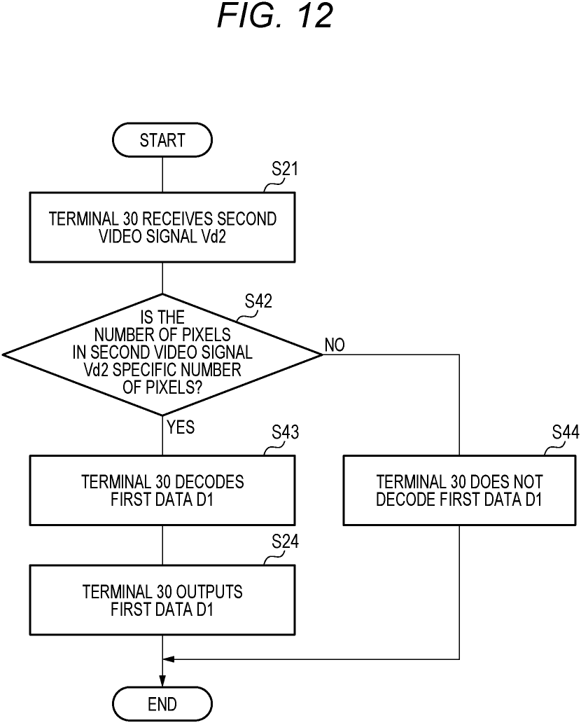

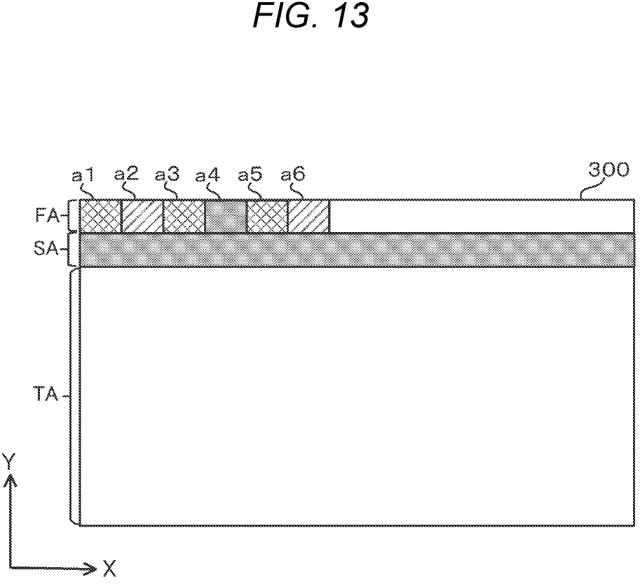

Hereinafter, an example of decoding processing executed by the terminal 30 in the modification 4 will be described with reference to FIG. 12. FIG. 12 is a flowchart showing the example of the decoding processing executed by the terminal 30 in the modification 4.

In the present modification, the terminal 30 determines whether to decode the second video signal Vd2 by reference to the number of pixels in the second video signal Vd2. Specifically, after step S21, the terminal 30 determines whether the number of pixels in the second video signal Vd2 is a specific number of pixels (FIG. 12: step S42). When the terminal 30 determines that the number of pixels in the second video signal Vd2 is the specific number of pixels (FIG. 12: Yes in step S42), the terminal 30 decodes the first data D1 based on the RGB values of the areas a1 to a6 in the second video signal Vd2 (FIG. 12: step S43). For example, when the video signal processing device 20d is set to expand the number of pixels in the first video signal Vd1 to 1280 × 724, the terminal 30 determines whether the number of pixels in the second video signal Vd2 is 1280 × 724. When the terminal 30 determines that the number of pixels in the second video signal Vd2 is 1280 × 724, the terminal 30 decodes the first data D1 based on the RGB values of the areas a1 to a6 in the second video signal Vd2. The terminal 30 outputs the decoded first data D1 (FIG. 12: step S24).

When the terminal 30 determines that the number of pixels in the second video signal Vd2 is not the specific number of pixels (FIG. 12: No in step S42), the terminal 30 does not decode the first data D1 based on the RGB values of the areas a1 to a6 in the second video signal Vd2 (FIG. 12: step S44).

### Effects of Modification 4 Related to Decoding Processing

The video signal processing device 20d can prevent the terminal 30 from executing unnecessary decoding processing. Specifically, the terminal 30 decodes the first data D1 only when the number of pixels in the second video signal Vd2 is a specific number of pixels. Therefore, when the number of pixels in the second video signal Vd2 is not the specific number of pixels, the terminal 30 does not decode the first data D1. Therefore, the terminal 30 does not execute unnecessary processing.

### Modification 5 of Video Signal Processing Device 20

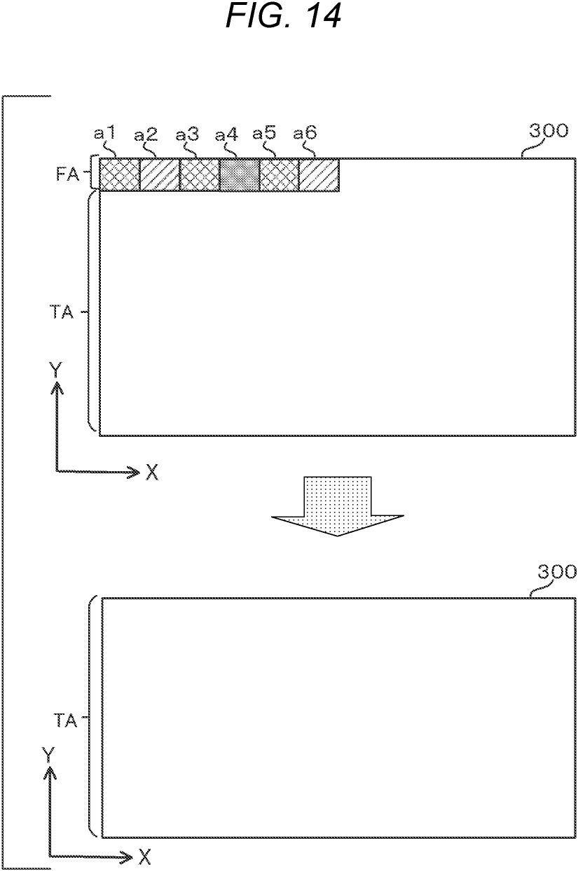

Hereinafter, a video signal processing device 20e according to a modification 5 will be described with reference to FIG. 13. FIG. 13 is a diagram showing an example of processing in the video signal processing device 20e. The video signal processing device 20e is different from the video signal processing device 20 in that RGB values of pixels in a second area SA are converted together with the areas a1 to a6.

A processing unit 201e (not shown) of the video signal processing device 20e designates the second area SA as shown in FIG. 13. The second area SA does not overlap the areas a1 to a6. A part of the second area SA is in contact with a part of the areas a1 to a6. The processing unit 201e sets the RGB values of the pixels in the second area SA to a single RGB value (for example, RGB = (0, 0, 0)).

The processing unit 201e designates, as a third area TA, an area other than the areas a1 to a6 and the second area SA. At this time, the second area SA exists between the areas a1 to a6 and the third area TA. A video is reproduced in the third area TA. That is, there is a high possibility that an RGB value of the third area changes for each frame. Therefore, when the areas a1 to a6 and the third area TA are in contact with each other at the time of generating the second video signal Vd2, the RGB value of the third area TA may become noise and affect RGB values of the areas a1 to a6. On the other hand, in the present modification, the areas a1 to a6 are in contact with the second area SA. The RGB values of the pixels in the second area SA are set to a single value, and thus there is a low possibility that the RGB value of the second area SA becomes noise and affects the RGB values of the areas a1 to a6.

### Application Example 1 of Processing in Terminal 30

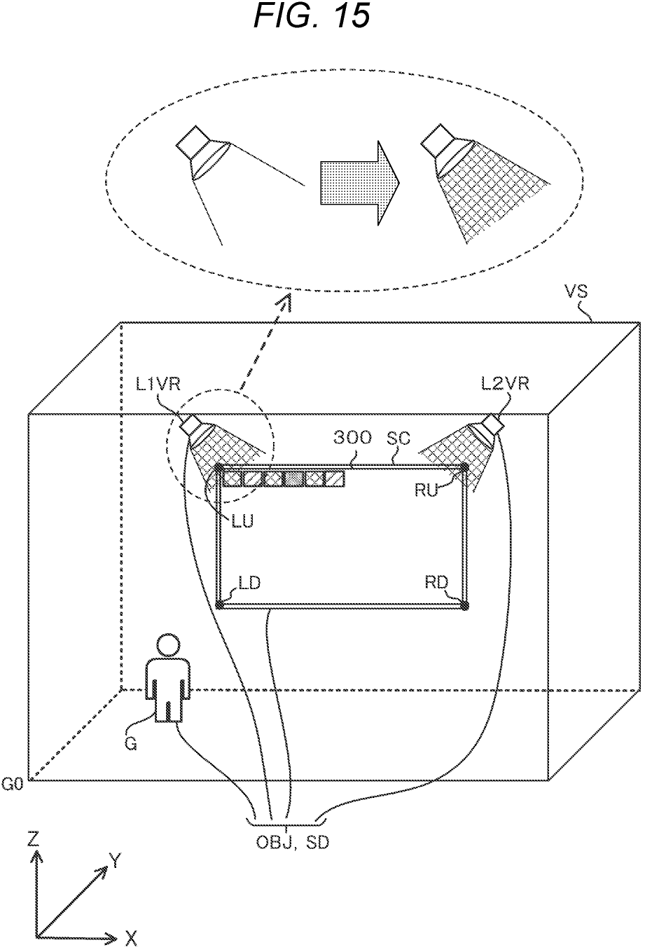

Hereinafter, an application example 1 of processing in the terminal 30 will be described with reference to FIG. 14. FIG. 14 is a diagram showing an example of the processing in the terminal 30.

In the present application example, the terminal 30 receives the second video signal Vd2. The terminal 30 generates a third video signal Vd3 by removing the areas a1 to a6 in the second video signal Vd2. In an example shown in FIG. 14, the processing unit 201b removes the first area FA including the areas a1 to a6. For example, when the number of pixels in the second video signal Vd2 before removal is 1280 × 720 and the number of pixels in the areas a1 to a6 is 1280 × 4, the processing unit 201b changes the number of pixels in the second video signal Vd2 to 1280 × 716. That is, the processing unit 201b changes a resolution of the second video signal Vd2.

Accordingly, the areas a1 to a6 are not displayed in a video displayed based on the third video signal Vd3. That is, the terminal 30 displays the video related to a video signal (an original video signal) before RGB values are replaced. Therefore, a user can view a distributed moving image without feeling a sense of discomfort.

In the present application example, the processing unit 201b may not necessarily remove the areas a1 to a6 by changing the resolution of the second video signal Vd2. For example, the processing unit 201b may change an RGB value of an area including the areas a1 to a6 to a single RGB value. For example, when the number of pixels in the areas a1 to a6 is 1280 × 4, the processing unit 201b changes an RGB value of each of the 1280 × 4 pixels to, for example, RGB value = (0, 0, 0). In this case, the resolution of the second video signal Vd2 remains at 1280 × 720.

### Application Example 1 of Video Signal Processing Devices 20 and 20a to 20e

Hereinafter, an application example 1 of the video signal processing devices 20 and 20a to 20e will be described with reference to the drawings. FIG. 15 is a diagram showing the application example 1 of the video signal processing devices 20 and 20a to 20e. In the application example, the video signal processing devices 20 and 20a to 20e output the second video signal Vd2 related to virtual reality (VR). The terminal 30 reproduces a VR video based on the second video signal Vd2. In this case, the terminal 30 is, for example, a PC. The terminal 30 displays a virtual 3D space on a display of the PC. Hereinafter, details of processing in the application example will be described.

The terminal 30 generates a virtual space VS based on, for example, virtual space generation data (not shown) stored in a host device in advance (see FIG. 15). Specifically, the virtual space generation data is data for determining a shape (a shape of a cube, a sphere, or the like), a size (coordinates of an end of the virtual space VS, or the like), or the like of the virtual space VS. For example, the virtual space generation data includes coordinates of an end of the virtual space VS in an X-axis direction, coordinates of an end of the virtual space VS in a Y-axis direction, and coordinates of an end of the virtual space VS in a Z-axis direction. FIG. 15 shows the virtual space VS having, for example, a cubic shape. The virtual space VS is represented by, for example, coordinates of x = 0 to 1, y = 0 to 1, and z = 0 to 1 with G0 in FIG. 14 as an origin.

In the present application example, the first data D1 includes space coordinate data SD of the virtual space VS. The space coordinate data SD is data indicating position information on an object OBJ which is a virtual object installed in the virtual space VS. The space coordinate data SD includes, for example, data indicating a position, a shape, a size, or the like of the object OBJ. The terminal 30 places the object OBJ (for example, a screen and illumination) in the virtual space VS based on the space coordinate data SD. In other words, the first data D1 includes the space coordinate data SD of the object OBJ to be displayed in the virtual space VS.

The terminal 30 acquires the space coordinate data SD from the second video signal Vd2 by decoding the second video signal Vd2. The terminal 30 performs display based on the space coordinate data SD. For example, the terminal 30 generates the virtual space VS based on the virtual space generation data stored in the host device. The terminal 30 reads the space coordinate data SD included in the second video signal. The terminal 30 places the object OBJ in the virtual space VS based on coordinates of the space coordinate data SD. In this way, the terminal 30 displays the virtual space VS based on the second video signal Vd2.

In the present application example, the object OBJ includes, for example, a screen SC that displays the second video signal Vd2 in the virtual space VS. In this case, the first data D1 includes the space coordinate data SD indicating a position of the screen SC. The terminal 30 displays the screen SC based on coordinates or the like of the screen SC. In other words, the terminal 30 displays the screen SC in the virtual space VS based on the space coordinate data SD. In this case, the space coordinate data SD includes coordinates of diagonal positions of the screen SC, center coordinates of the screen SC, a size of the screen SC, or the like. For example, the space coordinate data SD includes the coordinates of the diagonal positions (lower left LD: x1, y1, z1, upper left LU: x2, y2, z2, upper right RU: x3, y3, z3, lower right RD: x4, y4, z4) of the screen SC. The space coordinate data SD includes, for example, coordinates of lower left LD: (x1, y1, z1) = (0.2, 1.0, 0.4), upper left LU: (x2, y2, z2) = (0.2, 1.0, 0.7), upper right RU: (x3, y3, z3) = (0.8, 1.0, 0.7), and lower right RD: (x4, y4, z4) = (0.8, 1.0, 0.4). Accordingly, the terminal 30 displays an object of the screen SC in the virtual space VS. The terminal 30 displays a video based on the second video signal Vd2 on the screen SC in the virtual space VS.

The object OBJ includes, for example, information on illuminations L1VR and L2VR (see FIG. 15). The information on the illuminations L1VR and L2VR includes, for example, positions (coordinates) of the illuminations, or directions of the illuminations. The terminal 30 displays the illuminations L1VR and L2VR in the virtual space VS based on the coordinates of the illuminations L1VR and L2VR, the directions of the illuminations, or the like. The terminal 30 controls the illuminations L1VR and L2VR (for example, turning on, turning off, or changing of colors) based on illumination data embedded in the second video signal Vd2. Therefore, for example, a distributor can reproduce illumination in a live venue in a real world by setting the positions of the illuminations L1VR and L2VR based on a position of the illumination in the live venue in the real world or a direction of the illumination. Accordingly, a viewer can not only view a video of a live performance, but also obtain a sense of realism as if the viewer is listening to the live performance in a certain live house.

The information on the illuminations L1VR and L2VR may include, for example, information related to a model name of an illumination (a machine name of the illumination), or a function of the illumination (monochromatic illumination, color illumination, or the like). In this case, the terminal 30 stores, for example, a three-dimensional model image of illumination in advance. The three-dimensional model image of illumination is a model image that reproduces a shape, a color, or the like of an illumination in the real world. When the terminal 30 receives the information related to the model name of the illumination or the function of the illumination, the terminal 30 selects a three-dimensional model image of illumination corresponding to the model name of the illumination or the function of the illumination. The terminal 30 displays the illuminations L1VR and L2VR in the virtual space VS based on the selected three-dimensional model image of illumination. Accordingly, the terminal 30 displays, in the virtual space VS, the illuminations L1VR and L2VR that reproduce the shape or the like of the illumination in the real world. Therefore, the distributor can further reproduce the illumination or the like in the live venue.

For example, as shown in FIG. 15, the terminal 30 displays the virtual space VS in an overhead view. The viewer can view, via the terminal 30, the virtual screen SC existing in the virtual space VS. Accordingly, the viewer can obtain, for example, a sense of realism as if the viewer is viewing the live performance performed at the live venue from overhead. For example, the distributor prepares a video of a live performance scene as the first video signal Vd1. In this case, the live performance scene is displayed on the screen SC. Therefore, the viewer can view, in the virtual space VS, a state in which the live performance is performed.

The space coordinate data SD may include an origin of display in the virtual space VS. The origin of display in the virtual space VS is, for example, information indicating a viewing position of a viewer G in FIG. 15, and information indicating an origin of a viewpoint of the viewer. The space coordinate data SD includes, for example, information indicating that the viewing position of the viewer G (the origin of the viewpoint of the viewer G) is (x, y, z) = (0.1, 0.6, 0) (for example, a position of the viewer G shown in FIG. 14). In this case, the terminal 30 displays the virtual space VS at a viewpoint viewing a certain direction (for example, a direction of the screen SC) from the viewing position: (x, y, z) = (0.1, 0.6, 0). In other words, the terminal 30 displays the virtual space VS based on the origin of display. Accordingly, the viewer can not only view a video of a live performance, but also obtain a sense of realism as if the viewer is listening to the live performance in a certain live house.

The terminal 30 may change the viewing position of the viewer or the viewpoint of the viewer for each frame. For example, in an example shown in FIG. 15, the terminal 30 may switch the viewing position of the viewer G from (x, y, z) = (0.1, 0.6, 0) to (x, y, z) = (0.7, 0.6, 0). The terminal 30 may move the viewing position of the viewer G little by little in a positive direction of the X axis for each frame. Accordingly, the terminal 30 can switch between videos that reproduce camera work in a live video, move a camera in accordance with movement of a subject, or the like.

In the present application example, the first data D1 may include, for example, a control program (hereinafter, referred to as a program P) that executes processing related to the virtual space VS. For example, the video signal processing devices 20 and 20a to 20e generate the second video signal Vd2 by embedding the first data D1 including the program P in the first video signal Vd1. When the terminal 30 receives the second video signal Vd2, the terminal 30 reads the program P embedded in the second video signal Vd2. The terminal 30 generates the virtual space VS, the object OBJ, or the like by executing the program P. In this case, the program P is generated with, for example, HTML, or JavaScript (registered trademark).

The first data D1 may not necessarily include the screen SC and the illuminations L1VR and L2VR as the object OBJ. For example, when the first data D1 includes the program P, the program P may include position information or the like on the screen SC and the illuminations L1VR and L2VR (the position information or the like on the screen SC and the illuminations L1VR and L2VR may be embedded in the program P). In this case, the terminal 30 executes the program P to read the position information or the like on the screen SC and the illuminations L1VR and L2VR included in the program P. Therefore, the distributor embeds, in the program P, a model of illumination that reproduces the position of the illumination in the live venue, the shape of the illumination, or the like. The terminal 30 reads the model of illumination embedded in the program P to display, in the virtual space VS, the illuminations L1VR and L2VR reproducing the illumination in the live venue.

### Application Example 2 of Video Signal Processing Devices 20 and 20a to 20e

Hereinafter, an application example 2 of the video signal processing devices 20 and 20a to 20e will be described. The video signal processing devices 20 and 20a to 20e according to the application example 2 receive the first data D1 including acoustic control data. The video signal processing devices 20 and 20a to 20e generate the second video signal Vd2 based on the first data D1 including the acoustic control data, and output the second video signal Vd2 to the terminal 30. Accordingly, the terminal 30 controls, based on the acoustic control data, an audio of a moving image to be reproduced. The acoustic control data includes, for example, a volume value, a value of an effect (for example, an equalizer, or a delay), or data related to audio image localization processing. For example, when the acoustic control data includes the volume value, the terminal 30 increases or decreases a volume of the moving image to be reproduced according to the volume value.

### Application Example 3 of Video Signal Processing Devices 20 and 20a to 20e

Hereinafter, an application example 3 of the video signal processing devices 20 and 20a to 20e will be described. The video signal processing devices 20 and 20a to 20e according to the application example 3 receive the first data D1 including video control data. The video signal processing devices 20 and 20a to 20e generate the second video signal Vd2 based on the first data D1 including the video control data, and output the second video signal Vd2 to the terminal 30. The terminal 30 controls a moving image to be reproduced based on the video control data. The video control data includes, for example, data related to video division, data related to video effect processing (for example, screen muting or brightness adjustment), data related to a screen that displays a video, or data related to position information on a performer. For example, when the video control data includes data related to brightness of a video, the terminal 30 adjusts brightness of the moving image to be reproduced.

When the video control data includes the data related to the video division, for example, the terminal 30 divides the video into a plurality of pieces according to division data. The terminal 30 reproduces the divided videos on different screens. For example, a distributor prepares a plurality of cameras (for example, a first camera and a second camera) in a live venue. In a live performance scene, for example, the distributor captures an image of a stage of the live venue with the first camera, and captures an image of a face of a performer with the second camera. At this time, the video signal processing devices 20 and 20a to 20e receive video signals from the first camera and the second camera, respectively. The video signal processing devices 20 and 20a to 20e generate the first video signal Vd1 (hereinafter, referred to as a first video signal for division) in which both the video signal received from the first camera (hereinafter, referred to as a video signal of the first camera) and the video signal received from the second camera (hereinafter, referred to as a video signal of the second camera) are embedded.

The video signal processing devices 20 and 20a to 20e generate the second video signal Vd2 based on the first video signal for division. At this time, the video signal processing devices 20 and 20a to 20e embed, in the second video signal Vd2, information indicating on which screen among the plurality of screens the video signal of the first camera is to be displayed, and embed, in the second video signal Vd2, information indicating on which screen among the plurality of screens the video signal of the second camera is to be displayed. For example, the video signal processing devices 20 and 20a to 20e embed, in the second video signal Vd2, information (hereinafter, referred to as first information) indicating that the video signal of the first camera is to be displayed on a first screen, and information (hereinafter, referred to as second information) indicating that the video signal of the second camera is to be displayed on a second screen. The video signal processing devices 20 and 20a to 20e output the second video signal Vd2 to the terminal 30.

The terminal 30 divides the second video signal Vd2 into the video signal of the first camera and the video signal of the second camera. The terminal 30 transmits the video signal of the first camera and the video signal of the second camera to different screens. For example, the terminal 30 displays a video about the stage of the live venue (a video based on the video signal of the first camera) on the first screen based on the first information, and displays a video about the face of the performer (a video based on the video signal of the second camera) on the second screen based on the second information.

The terminal 30 may display the video signal of the first camera and the video signal of the second camera on one screen by, for example, switching between the video signal of the first camera and the video signal of the second camera. In this case, a user of the terminal 30 may execute an operation of switching between the video signal of the first camera and the video signal of the second camera via the terminal 30.

The video control data may include data related to camera work. The data related to camera work is, for example, an order of the video signals to be displayed on the screen. For example, the video control data includes data for displaying the video based on the video signal of the first camera, the video based on the video signal of the second camera, and the video based on the video signal of the first camera on the first screen in this order. In this case, the first screen displays the video based on the video signal of the first camera, the video based on the video signal of the second camera, and the video based on the video signal of the first camera in this order.

In the application example 3, the first data D1 may include, for example, position data of the performer. The terminal 30 may change, based on the position data of the performer, a position of a screen on which the video about the face of the performer is to be reproduced. For example, the first data D1 includes information such as a direction in which the performer moves during a performance or a movement distance. In this case, the terminal 30 reads the first data D1 to obtain the information on the direction in which the performer moves during the performance or the movement distance. For example, the terminal 30 moves the second screen (the screen for reproducing the video about the face of the performer) in the same direction as the direction in which the performer moves. At this time, the terminal 30 changes a movement amount of the second screen based on the information on the movement distance of the performer. In the present application example, the terminal 30 may execute audio image localization processing based on the position data of the performer. For example, the terminal 30 may execute the audio image localization processing to localize an audio generated by a performance of a performer C (not shown) in a direction in which the performer C moves.

### Application Example 4 of Video Signal Processing Devices 20 and 20a to 20e

Hereinafter, an application example 4 of the video signal processing devices 20 and 20a to 20e will be described. The video signal processing devices 20 and 20a to 20e according to the application example 4 embed information indicating a data type of the first data D1 in the second video signal Vd2. The data type is label information for identifying a type of the first data D1. The data type is, for example, information indicating that the first data D1 is acoustic control data, video control data, or the like. That is, the first data D1 includes the data type that is the label information for identifying the type of the first data D1. The video signal processing devices 20 and 20a to 20e embed the data type in the second video signal Vd2. The terminal 30 analyzes the data type embedded in the second video signal Vd2. As a result of the analysis, when the terminal 30 determines that a data type indicating control data executable by the terminal 30 is included in the first data D1, the terminal 30 executes control based on the control data. For example, when an application for acoustic control is installed in the terminal 30, the terminal 30 determines whether the data type of the acoustic control data is included in the second video signal Vd2. When the terminal 30 determines that the data type of the acoustic control data is included in the second video signal Vd2, the terminal 30 controls an acoustic device based on the acoustic control data.

### Other Embodiments

The present invention is not limited to the video signal processing devices 20 and 20a to 20e according to the present invention, and may be modified within the scope of the gist of the present invention. Configurations of the video signal processing devices 20 and 20a to 20e may be combined freely.

The processing in the video signal processing devices 20 and 20a to 20e in the first embodiment is not limited to an example shown in FIG. 4. For example, the processing unit 201 may receive the first data D1 after receiving the first video signal Vd1. For example, the processing unit 201 may receive the first video signal Vd1 after generating the second data D2.

The video signal processing devices 20 and 20a to 20e may not necessarily receive the first data D1 and the first video signal Vd1 from a device (hereinafter, referred to as a device X) different from the video signal processing device 20 (not shown). The video signal processing devices 20 and 20a to 20e may generate the first data D1 or the first video signal Vd1 in their host devices, for example. In this case, for example, an application program for generating the first data D1 or an application program for generating the first video signal Vd1 is installed in the video signal processing devices 20 and 20a to 20e.

The number of frames included in the first video signal Vd1 is not limited to an example of two shown in FIG. 3.

The first video signal Vd1 may not necessarily include two or more frames. The first video signal Vd1 may include one frame alone. In this case, the first video signal Vd1 is a still image such as a photograph.

By compressing the second video signal Vd2 without increasing a compression ratio (by compressing with high image quality), an RGB value is less likely to change at and near a boundary between the areas a1 to a6 and the area other than the areas a1 to a6. Therefore, a possibility that the first data D1 can be correctly decoded is increased.

The byte value of the first data D1 may be a value other than “0×11” and “0×13”.

The byte value of the identifier data ID may be a value other than “0×55”. For example, the video signal processing devices 20 and 20a to 20e may set a bit string of the identifier data ID based on, for example, a combination of dots that are less likely to appear in the video signal. For example, when an area with 4 × 4 pixels is defined as one dot, there is a low possibility that a dot with RGB = (255, 0, 0), a dot with RGB = (0, 255, 0), and a dot with RGB (0, 0, 255) are arranged in this order in the video signal. Therefore, the video signal processing devices 20 and 20a to 20e set the bit string of the identifier data ID such that an RGB value of the area a1 is (255, 0, 0), an RGB value of the area a2 is (0, 255, 0), and an RGB value of the area a3 is (0, 0, 255). That is, the video signal processing devices 20 and 20a to 20e may set the bit string of the identifier data ID to “10001000” (that is, “0×88”).

The number of pixels in each of the areas a1 to a6 may not necessarily be four pixels. For example, the number of pixels in each of the areas a1 to a6 may be eight pixels or the like.

The video signal processing devices 20 and 20a to 20e may not necessarily designate the second area SA.

The number of pixels in each of the areas a1 to a6 may not necessarily be the same as the number of pixels in the block unit of the second video signal Vd2.

The video signal processing devices 20 and 20a to 20e may not necessarily independently compress each of the frames included in the second video signal Vd2.

The first data D1 may not necessarily include the illumination data.

The first data D1 may not necessarily include the space coordinate data SD.

The object OBJ may not necessarily include the screen SC.

In the application example 1, the object OBJ may not necessarily include the information on the two illuminations (the illuminations L1VR and L2VR). For example, the object OBJ may include information on one illumination, and the object OBJ may include information on three or more illuminations.

The first data D1 may not necessarily expand the number of pixels in the first video signal Vd1. The video signal processing devices 20 and 20a to 20e may not necessarily designate the expanded areas in the first video signal Vd1 as the areas a1 to a6.

The video signal processing devices 20 and 20a to 20e may not necessarily generate the third video signal Vd3 by removing the areas a1 to a6 in the second video signal Vd2.

The terminal 30 may not necessarily determine whether the identifier data ID is included in the second video signal Vd2. In this case, the terminal 30 may decode the first data D1 even when it is not determined that the identifier data ID is included in the second video signal Vd2.

The terminal 30 may not necessarily determine whether the number of pixels in the second video signal Vd2 is a specific number of pixels. In this case, the terminal 30 may decode the first data D1 even when it is not determined that the number of pixels is the specific number of pixels.

The first data D1 may further include data other than the identifier data ID. The first data D1 may include, for example, data indicating the number of pieces of data, or a checksum. The data indicating the number of pieces of data is a byte string in which the number of pieces of data of the first data D1 is recorded. The checksum is data for confirming whether the second video signal Vd2 before being transmitted to the terminal 30 and the second video signal Vd2 after being transmitted to the terminal 30 are the same. For example, the video signal processing devices 20 and 20a to 20e calculate the checksum based on a data string of the first data D1 before being transmitted to the terminal 30. The video signal processing devices 20 and 20a to 20e calculate the checksum based on a data string of the first data D1 after being transmitted to the terminal 30. At this time, when the checksum is correct, the terminal 30 may determine that the decoding of the second video signal Vd2 is normally executed. The first data D1 may include, for example, an error correction code such as a Reed-Solomon code.

The terminal 30 may determine whether the decoding of the first data D1 is normally executed based on the identifier data ID. For example, when the byte value of “0×55” can be decoded, the terminal 30 determines that the first data D1 can be decoded. On the other hand, when the byte value of “0×55” cannot be decoded, the terminal 30 determines that the first data D1 cannot be decoded.

The first data D1 may include data other than the acoustic control data described in the application example 2 or the video control data described in the application example 3. For example, the first data D1 may include control data for a PC or the like (for example, control data such as on/off of a power supply), or control data for a home appliance controller (for example, opening/closing data for a curtain, control data of on/off of indoor illumination, or on/off of a fan).

In the modification 4, when the terminal 30 receives the second video signal Vd2 including the expanded area EA, the terminal 30 may remove the area EA. For example, when the number of pixels in the second video signal Vd2 is expanded from 1280 × 720 to 1280 × 724 with the area EA, the terminal 30 may change the number of pixels in the second video signal Vd2 to 1280 × 720. That is, the terminal 30 may change the resolution of the second video signal Vd2. Alternatively, the terminal 30 may change the RGB values of the expanded area EA to a single RGB value. When the terminal 30 removes the expanded area EA from the second video signal Vd2 by changing the resolution of the second video signal Vd2, the terminal 30 displays the original video signal (the first video signal Vd1 before conversion). Therefore, when the terminal 30 changes the resolution of the second video signal Vd2, the user can view the distributed moving image without feeling a sense of discomfort as compared with a case where the terminal 30 changes the RGB values of the area EA to a single RGB value.

The first data D1 may include both the identifier data ID and the data type. In this case, in the first data D1, the identifier data ID and the data type are arranged from a most significant bit in an order of the identifier data ID and the data type. The video signal processing devices 20 and 20a to 20e generate the second video signal Vd2 by embedding the first data D1 including the identifier data ID and the data type in the first video signal Vd1. When it is determined that the identifier data ID is included in the second video signal Vd2, the terminal 30 decodes the data type.

What is claimed is:

1. A video signal processing method comprising:
receiving first data;
generating second data by converting the first data into an RGB value;
receiving a first video signal including an RGB value for each pixel;
generating a second video signal from the first video signal by replacing an RGB value of a pixel in a first area in the first video signal with the RGB value of the second data; and
outputting the second video signal.

2. The video signal processing method according to claim 1, further comprising:
compressing the second video signal in each of block units of which the number of pixels is the same as the number of pixels in the first area,
wherein the second video signal output is the compressed second video signal.

3. The video signal processing method according to claim 1, wherein
the first video signal includes at least two frames,
the generating:
replaces an RGB value of the first area in each of the at least two frames with the RGB value of the second data; and
compresses each of the at least two frames included in the second video signal independently, and
the second video signal output is the compressed second video signal.

4. The video signal processing method according to claim 1, wherein
the first data includes illumination data for controlling illumination.

5. The video signal processing method according to claim 1, wherein
the first data includes space coordinate data of an object to be displayed in a virtual space,
the object includes a screen configured to display the second video signal, and
the screen is displayed in the virtual space based on the space coordinate data.

6. The video signal processing method according to claim 1, wherein
the first data includes space coordinate data of a virtual space,
the space coordinate data includes an origin of display in the virtual space, and
the virtual space is displayed based on the origin of display.

7. The video signal processing method according to claim 1, wherein
the first data includes identifier data for identifying that the first data is embedded.

8. The video signal processing method according to claim 7, further comprising:
receiving the second video signal;
determining whether the identifier data is included in the second video signal; and
decoding the first data based on the RGB value of the pixel in the first area in the second video signal, in a state where the identifier data is determined to be included in the second video signal.

9. The video signal processing method according to claim 1, further comprising:
receiving the second video signal;
generating a third video signal from the second video signal by removing the first area in the second video signal; and
outputting the third video signal.

10. A video signal processing device comprising:
a memory storing instructions; and
a processor that implements the instructions to
receive first data and a first video signal including an RGB value for each pixel;
generate second data by converting the first data into an RGB value; and
generate a second video signal from the first video signal by replacing an RGB value of a pixel in a first area in the first video signal with the RGB value of the second data; and
output the second video signal.

11. The video signal processing device according to claim 10, wherein
the processor implements the instructions to compress the second video signal in each of block units of which the number of pixels is the same as the number of pixels in the first area, and
the second video signal output is the compressed second video signal.

12. The video signal processing device according to claim 10, wherein
the first video signal includes at least two frames,
the processor, in generating the second video signal:
replaces an RGB value of the first area in each of the at least two frames with the RGB value of the second data; and
compresses each of the at least two frames included in the second video signal independently, and
the second video signal output is the compressed second video signal.

13. The video signal processing device according to claim 10, wherein
the first data includes illumination data for controlling illumination.

14. The video signal processing device according to claim 10, wherein
the first data includes identifier data for identifying that the first data is embedded.

15. The video signal processing device according to claim 10, wherein
the video signal processing device is communicably connected to a terminal different from the video signal processing device.

16. The video signal processing device according to claim 15, wherein
the terminal is configured to receive the second video signal;
generate a third video signal from the second video signal by removing the first area in the second video signal; and
output the third video signal.

17. The video signal processing device according to claim 15, wherein
the terminal is configured to display a virtual space based on the second video signal,
the first data includes space coordinate data of an object to be displayed in the virtual space,
the object includes a screen configured to display the second video signal, and
the terminal is configured to display the screen in the virtual space based on the space coordinate data.

18. The video signal processing device according to claim 15, wherein
the terminal is configured to display a virtual space based on the second video signal,
the first data includes space coordinate data of the virtual space,
the space coordinate data includes an origin of display in the virtual space, and
the terminal is configured to display the virtual space based on the origin of display.

19. The video signal processing device according to claim 15, wherein
the first data includes identifier data for identifying a type of the first data,
the terminal is configured to:
receive the second video signal,
determine whether the identifier data is included in the second video signal; and
decode the first data based on the RGB value of the pixel in the first area in the second video signal, in a state where the terminal determines that the identifier data is included in the second video signal.
